(19) United States
(12) Patent Application Publication
(10) Pub. No.: US 2022/0089395 A1
(43) Pub. Date: Mar. 24, 2022

(54) MEDIUM CONVEYING APPARATUS INCLUDING TWO MAGNETS FOR ATTRACTING MAGNETIC MATERIAL MOVING WITH CONVEYED MEDIUM

(71) Applicant: PFU LIMITED, Kahoku-shi (JP)

(72) Inventor: Hiroshi Shiraiwa, Kahoku-shi (JP)

(21) Appl. No.: 17/397,711

(22) Filed: Aug. 9, 2021

(30) Foreign Application Priority Data
Sep. 18, 2020 (JP) 2020-157410

(51) Int. Cl. B65H 7/20; B65H 5/06

(52) U.S. Cl. CPC B65H 7/20; B65H 2515/71; B65H 5/062

(57) ABSTRACT

A medium conveying apparatus includes a conveying roller to convey a medium, a first magnet to generate a first magnetic force for attracting a magnetic material moving with the medium conveyed by the conveying roller, and a second magnet to generate a second magnetic force for attracting the magnetic material attracted to the first magnet.

### CROSS-REFERENCE TO RELATED APPLICATIONS

This application is based upon and claims the benefit of priority of prior Japanese Patent Application No. 2020-157410, filed on Sep. 18, 2020, the entire contents of which are incorporated herein by reference.

### TECHNICAL FIELD

Embodiments discussed in the present specification relate to medium conveyance.

### BACKGROUND

In a medium conveying apparatus such as a scanner to convey and image a plurality of media, a magnetic material such as a staple or a clip which has stitched the plurality of media may be mixed between the plurality of media collectively conveyed, and move with the media. When the staple or the clip, etc., is conveyed, a medium conveyance path or an imaging surface of an imaging device, etc., may be damaged.

A document conveying apparatus to remove a magnetic material such as a clip, a staple needle, etc., by a magnet is disclosed Japanese Unexamined Patent Application Publication (Kokai) No. 2002-362754).

### SUMMARY

According to some embodiments, a medium conveying apparatus includes a conveying roller to convey a medium, a first magnet to generate a first magnetic force for attracting a magnetic material moving with the medium conveyed by the conveying roller, and a second magnet to generate a second magnetic force for attracting the magnetic material attracted to the first magnet.

### BRIEF DESCRIPTION OF DRAWINGS

FIG. 1 is a perspective view illustrating a medium conveying apparatus 100.

FIG. 2 is a diagram for illustrating a conveyance path inside the medium conveying apparatus 100.

FIG. 3A is a schematic diagram for illustrating a removal mechanism 118.

FIG. 3B is a schematic diagram for illustrating the removal mechanism 118.

FIG. 4 is a perspective view of a second magnet 118d.

FIG. 5A is a table illustrating a relation between a distance from a magnet, a magnetic flux density and a force applied on a magnetic material.

FIG. 5B is a graph 500 illustrating the relations illustrated in the table of FIG. 5A.

FIG. 6 is a block diagram illustrating a schematic configuration of the medium conveying apparatus 100.

FIG. 7 is a diagram illustrating schematic configurations of a storage device 140 and a processing circuit 150.

FIG. 8 is a flowchart illustrating an operation example of the medium reading processing.

FIG. 9 is a schematic diagram for illustrating a characteristic of an ultrasonic signal.

FIG. 10A is a schematic diagram for illustrating another removal mechanism 218.

FIG. 10B is a schematic diagram for illustrating another removal mechanism 218.

FIG. 11 is a block diagram illustrating a schematic configuration of another medium conveying apparatus 300.

FIG. 12 is a flowchart illustrating another operation example of the medium reading processing.

FIG. 13 is a diagram illustrating a schematic configuration of a processing circuit 450 according to another embodiment.

### DESCRIPTION OF EMBODIMENTS

It is to be understood that both the foregoing general description and the following detailed description are exemplary and explanatory, and are not restrictive of the invention, as claimed.

Hereinafter, a medium conveying apparatus, a method and a computer-readable, non-transitory medium storing a computer program according to an embodiment, will be described with reference to the drawings. However, it should be noted that the technical scope of the invention is not limited to these embodiments, and extends to the inventions described in the claims and their equivalents.

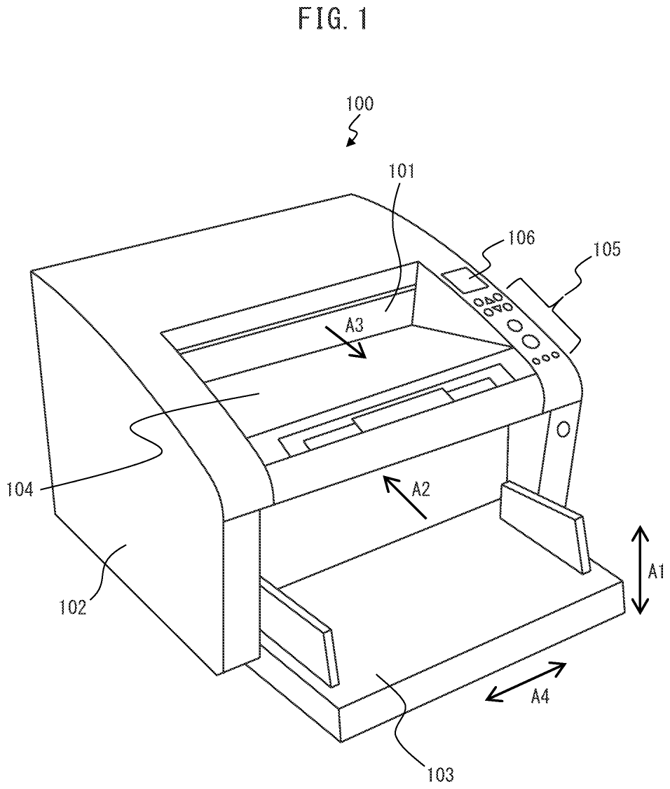

FIG. 1 is a perspective view illustrating a medium conveying apparatus 100 configured as an image scanner. The medium conveying apparatus 100 conveys and images a medium being a document. The medium is a paper, a thick paper, a card, etc. The medium conveying apparatus 100 may be a fax machine, a copying machine, a multifunctional peripheral (MFP), etc. A conveyed medium may not be a document but may be an object being printed on etc., and the medium conveying apparatus 100 may be a printer etc.

The media conveying device 100 includes a first housing 101, a second housing 102, a medium tray 103, the ejection tray 104, an operation device 105 and a display device 106, etc.

The first housing 101 is located on an upper side of the medium conveying apparatus 100 and is engaged with the second housing 102 by hinges so as to be opened and closed at a time of medium jam, during cleaning the inside of the medium conveying apparatus 100, etc.

The medium tray 103 is engaged with the second housing 102 in such a way as to be able to place a medium to be conveyed. The medium tray 103 is provided on a side surface of the second housing 102 on a medium supply side to be movable in a substantially vertical direction (height direction) A1 by a motor (not shown). The medium tray 103 is located at a position of a lower end to easily place a medium on the medium tray 103 when the medium is not conveyed, and lifts to a position at which the medium placed on the uppermost side is in contact with a pick roller to be described later when the medium is conveyed. The ejection tray 104 is formed on the first housing 101 capable of holding the ejected medium, to load the ejected medium.

The operation device 105 includes an input device such as a button, and an interface circuit acquiring a signal from the input device, receives an input operation by a user, and outputs an operation signal based on the input operation by the user. The display device 106 includes a display including a liquid crystal or organic electro-luminescence (EL), and an interface circuit for outputting image data to the display, and displays the image data on the display.

In FIG. 1, an arrow A2 indicates a medium conveying direction, an arrow A3 indicates a medium ejecting direction, and an arrow A4 indicates a width direction perpendicular to the medium conveying direction. Hereinafter, upstream refers to upstream of the medium conveying direction A2 or the medium ejecting direction A3, downstream refers to downstream of the medium conveying direction A2 or the medium ejecting direction A3

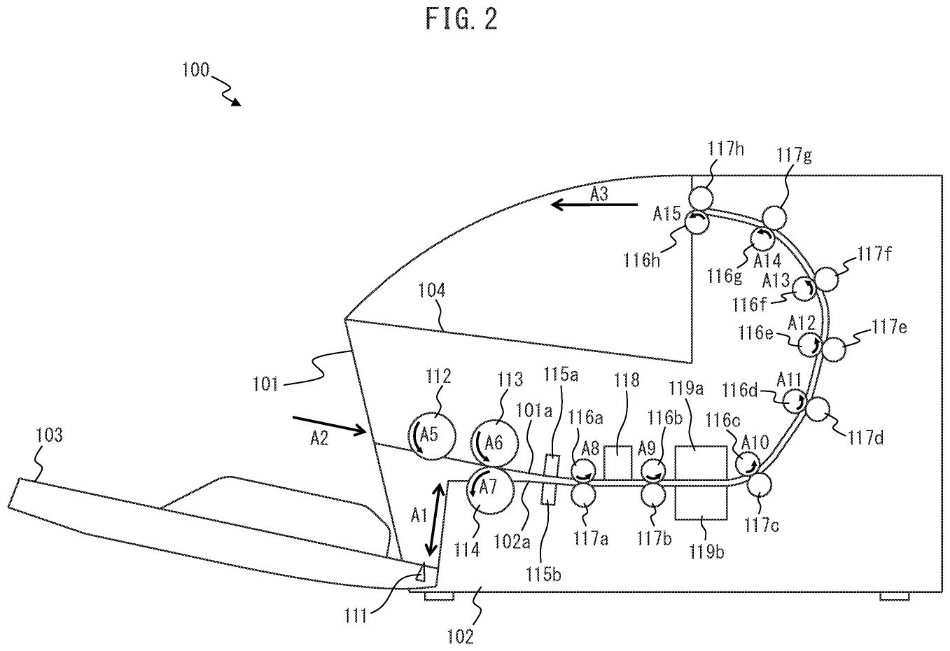

FIG. 2 is a diagram for illustrating a conveyance path inside the medium conveying apparatus 100.

The conveyance path inside the medium conveying apparatus 100 includes a medium sensor 111, a pick roller 112, a feed roller 113, a brake roller 114, an ultrasonic transmitter 115a, an ultrasonic receiver 115b, first to eighth conveyance rollers 116a to 116h, first to eighth driven rollers 117a to 117h, a removal mechanism 118, a first imaging device 119a and a second imaging device 119b, etc.

The numbers of each of the pick roller 112, the feed roller 113, the brake roller 114, the first to eighth conveyance rollers 116a to 116h and/or the first to eighth driven rollers 117a to 117h is not limited to one, and may be plural. In that case, the plurality of pick rollers 112, the feed rollers 113, the brake rollers 114, the first to eighth conveyance rollers 116a to 116h and/or the first to eighth driven rollers 117a to 117h are spaced and located alongside in the width direction A4, respectively. Hereinafter, the first imaging device 119a and the second imaging device 119b may be collectively referred to as imaging devices 119.

The surface of the first housing 101 facing the second housing 102 forms a first guide 101a of the medium conveyance path, and the surface of the second housing 102 facing the first housing 101 forms a second guide 102a of the medium conveyance path. The first guide 101a is formed of a ferromagnetic material such as iron, cobalt, nickel or gadolinium. The first guide 101a may be formed of a material other than a magnetic material.

The medium sensor 111 is located on the medium tray 103, i.e., on the upstream side of the feed roller 113 and the brake roller 114, to detect a placing state of the medium in the medium tray 103. The medium sensor 111 determines whether or not the medium is placed on the medium tray 103, by a contact detection sensor to pass a predetermined current when a medium is in contact or a medium is not in contact. The medium sensor 111 generates and outputs a medium signal whose signal value changes in a state where the medium is placed on the medium tray 103 and a state where it is not placed.

The pick roller 112 is provided in the first housing 101, and comes into contact with the medium placed on the medium tray 103 lifted to a height substantially equal to that of the medium conveyance path to feed the medium to the downstream side.

The feed roller 113 is located in the first housing 101, and on the downstream side of the pick roller 112, to feed the medium placed on the medium tray 103 and fed by the pick roller 112 toward the further downstream side. The brake roller 114 is located in the second housing 102 and is located to face the feed roller 113. The feed roller 113 and the brake roller 114 perform a medium separation operation to separate the media and feed them one by one. The feed roller 113 is located on the upper side with respect to the brake roller 114, the medium conveying apparatus 100 feeds the medium by a so-called top-first type.

The ultrasonic transmitter 115a and the ultrasonic receiver 115b are located on the downstream side of the feed roller 113 and the brake roller 114 and on the upstream side of the first to eighth conveyance rollers 116a to 116h and the first to eighth driven rollers 117a to 117h. The ultrasonic transmitter 115a and the ultrasonic receiver 115b are located close to the conveyance path of a medium in such a way as to face one another with the conveyance path in between. The ultrasonic transmitter 115a outputs an ultrasonic wave. On the other hand, the ultrasonic receiver 115b receives an ultrasonic wave being transmitted by the ultrasonic transmitter 115a and passing through a medium, and generates and outputs an ultrasonic signal being an electric signal corresponding to the received ultrasonic wave. The ultrasonic transmitter 115a and the ultrasonic receiver 115b may be hereinafter collectively referred to as an ultrasonic sensor 115.

The first to eighth conveyance rollers 116a to 116h and the first to eighth driven rollers 117a to 117h are provided on the downstream side of the feed roller 113 and the brake roller 114, to convey the medium fed by the feed roller 113 and the brake roller 114 toward the downstream side. The first to eighth conveyance rollers 116a to 116h and the first to eighth driven rollers 117a to 117h are located to face each other with the medium conveyance path in between. The pick roller 112, the feed roller 113, the brake roller 114, the first conveyance roller 116a and the first driven roller 117a are examples of a conveying roller to convey a medium.

The first imaging device 119a is an example of an imaging device, and is provided on the downstream side of the first conveyance roller 116a, the first driven roller 117a and the removal mechanism 118 in the medium conveying direction A2. The first imaging device 119a includes a line sensor based on a unity-magnification optical system type contact image sensor (CIS) including an imaging element based on a complementary metal oxide semiconductor (CMOS) linearly located in a main scanning direction. Further, the first imaging device 119a includes a lens for forming an image on the imaging element, and an A/D converter for amplifying and analog-digital (A/D) converting an electric signal output from the imaging element. The first imaging device 119a generates and outputs an input image by imaging a front side of the medium conveyed by the conveying roller.

Similarly, the second imaging device 119b is an example of the imaging device, and is provided on the downstream side of the first conveyance roller 116a, the first driven roller 117a and the removal mechanism 118 in the medium conveying direction A2. The second imaging device 119b includes a line sensor based on a unity-magnification optical system type CIS including an imaging element based on a CMOS linearly located in a main scanning direction. Further, the second imaging device 119b includes a lens for forming an image on the imaging element, and an A/D converter for amplifying and analog-digital (A/D) converting an electric signal output from the imaging element. The second imaging device 119b generates and outputs an input image by imaging a back side of the medium conveyed by the conveying roller.

Only either of the first imaging device 119a and the second imaging device 119b may be located in the medium conveying apparatus 100 and only one side of a medium may be read. Further, a line sensor based on a unity-magnification optical system type CIS including an imaging element based on charge coupled devices (CCDs) may be used in place of the line sensor based on a unity-magnification optical system type CIS including an imaging element based on a CMOS. Further, a line sensor based on a reduction optical system type line sensor including an imaging element based on CMOS or CCDs.

A medium placed on the medium tray 103 is conveyed in the medium conveying direction A2 between the first guide 101a and the second guide 102a by the pick roller 112 rotating in a medium feeding direction A5 and the feed roller 113 rotating in a medium feeding direction A6. On the other hand, when a plurality of media are placed on the medium tray 103, only a medium in contact with the feed roller 113, out of the media placed on the medium tray 103 is separated, by the brake roller 114 rotating in a direction A7 opposite to the medium feeding direction.

The medium is fed to an imaging position of the imaging device 119 while being guided by the first guide 101a and the second guide 102a, by the first to second conveyance rollers 116a to 116b rotating in directions of arrows A8 to A9, respectively, and is imaged by the imaging device 119. The medium is ejected on the ejection tray 104 by the third to eighth conveyance rollers 116c to 116h rotating in directions of arrows A10 to A15, respectively. The ejection tray 104 loads the medium ejected by the eighth conveyance roller 116h.

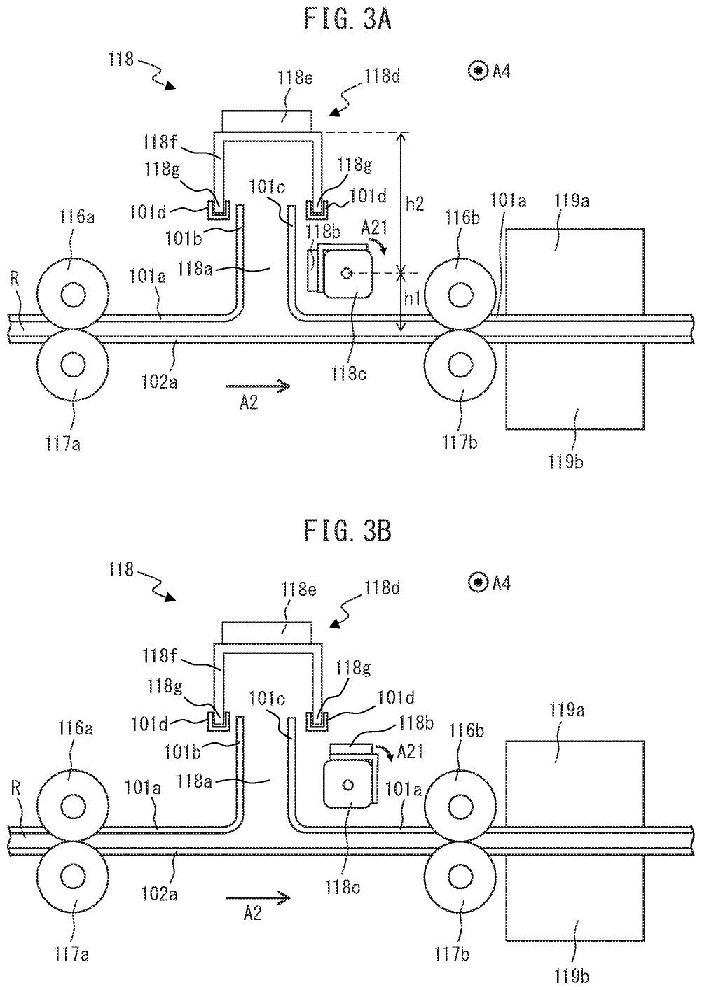

FIG. 3A and FIG. 3B are schematic diagrams for illustrating the removal mechanism 118. FIG. 3A and FIG. 3B are schematic diagrams of a portion between the first conveyance roller 116a and the second conveyance roller 116b in the medium conveyance path viewed from the side.

As illustrated in FIGS. 3A and 3B, the removal mechanism 118 is located between the first conveyance roller 116a and the second conveyance roller 116b, i.e., between the conveying roller and the imaging device 119 in the medium conveying direction A2.

The removal mechanism 118 includes a hole 118a, a first magnet 118b, a moving mechanism 118c and a second magnet 118d, etc.

As illustrated in FIGS. 3A and 3B, a part of the first guide 101a formed above the medium conveyance path R is bent upward at a substantially right angle between the first conveyance roller 116a and the second conveyance roller 116b in the medium conveying direction A2. Two side surfaces 101b, 101c extending upwardly and facing each other are formed by the portion folded upwardly of the first guide 101a, and thereby, the hole 118a is provided between the side surfaces 101b and 101c.

The first magnet 118b is a permanent magnet such as an alnico magnet, a ferrite magnet, a neodymium magnet. The first magnet 118b is formed in a plate shape extending in the width direction A4, and is located above the medium conveyance path R so as to face a surface opposite to the hole 118a, of the side surface 101c located on the downstream side of the side surface 101b. The first magnet 118b generates a first magnetic force for attracting a magnetic material, such as a staple or a clip, moving with the medium conveyed by the conveying roller. When the first guide 101a is formed of a ferromagnetic material, the side surface 101c of the first guide 101a becomes magnetized by the first magnetic force of the first magnet 118b, and functions as a magnet. The first magnet 118b may be located in a range capable of attracting the magnetic material moving with the medium by the first magnetic force, and may be located so as to be in contact with the side surface 101c or may be located so as to be apart from the side surface portion 101c.

The moving mechanism 118c is formed in a prism shape extending in the width direction A4, and is located on the opposite side of the hole 118a with respect to the side surface 101c. The moving mechanism 118c is rotatably provided in a direction of arrow A21 about a rotation axis extending in the width direction A4 by a driving force from a second motor which will be described later. The first magnet 118b is attached to one side surface extending in the width direction A4 of the moving mechanism 118c, along the width direction A4. The moving mechanism 118c rotates by the driving force from the second motor to move the first magnet 118b between an opposed position opposing the side surface 101c and a non-opposed position not opposing the side surface 101c.

The moving mechanism 118c may move the first magnet by a method other than rotation. For example, the moving mechanism 118c may include a pinion rotated by a driving force from the second motor, and a rack engaged with the pinion to slide according to the rotation of the pinion. In this case, the moving mechanism 118c slides the first magnet between the opposed position and the non-opposed position by the driving force from the second motor.

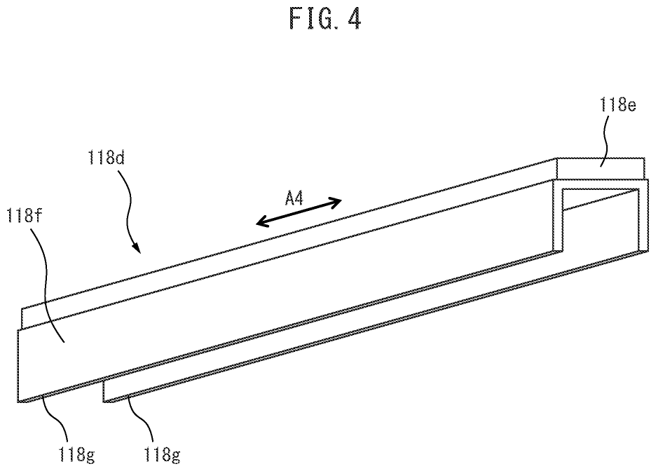

FIG. 4 is a perspective view of the second magnet 118d.

As illustrated in FIG. 3A, FIG. 3B, and FIG. 4, the second magnet 118d has an opening, and is located above the first magnet 118b so that the opening opens downward on an upper end side of the two side surface portions 101b and 101c and the second magnet 118d faces the hole 118a. The second magnet 118d includes a magnet member 118e and an accommodation member 118f.

The magnet member 118e is a permanent magnet such as an alnico magnet, a ferrite magnet, a neodymium magnet. The magnet member 118e is formed in a plate shape extending in the width direction A4. The accommodation member 118f is formed of a ferromagnetic material such as iron, cobalt, nickel, gadolinium, etc. The accommodation member 118f is formed in a U-shaped plate shape extending in the width direction A4 so as to have an opening extending along the width direction A4. The magnet member 118e is attached so as to face a surface opposite to the opening, of the bottom of the opening of the accommodation member 118f. The second magnet 118d generates a second magnetic force for attracting the magnetic material attracted to the first magnet 118b. The accommodation member 118f becomes magnetized by the second magnetic force of the magnet member 118e, and functions as a magnet. The magnet member 118e may be located in a range capable of attracting the magnetic material attracted to the first magnet 118b by the second magnetic force, and may be located so as to be in contact with the accommodation member 118f, or may be located so as to be apart from the accommodation member 118f. The accommodation member 118f may be formed of a material other than a magnetic material. The second magnet 118d may be formed of a single member which is a permanent magnet.

The first magnetic force by the first magnet 118b is set so that the first magnetic force applied to a magnetic material existing in a range from a position opposing the hole 118a in the medium conveyance path R to the side surface 101c is larger than the gravitational force applied to the magnetic material when the first magnet 118b is located at the opposed position. The second magnetic force by the second magnet 118d is set so that the second magnetic force applied to a magnetic material existing in a range from the side surface 101c to the accommodation member 118f is larger than the gravitational force applied to the magnetic material.

The first magnetic force and the second magnetic force are set so that the first magnetic force applied to the magnetic material existing in the range from the position opposing the hole 118a in the medium conveyance path R to the side surface 101c is larger than the second magnetic force applied to the magnetic material when the first magnet 118b is located at the opposed position. The first magnetic force and the second magnetic force are set so that the first magnetic force applied to the magnetic material existing in the range from the side surface 101c to the accommodation member 118f is smaller than the second magnetic force applied to the magnetic material when the first magnet 118b is located at the non-opposed position. The first magnetic force and the second magnetic force are set so that the first magnetic force applied to a magnetic material accommodated in the accommodation member 118f is smaller than the second magnetic force applied to the magnetic material regardless of a position where the first magnet 118b is located.

The first housing 101 is provided with a rail member 101d extending in the width direction A4 and engaging with a lower end portion 118g of the accommodation member 118f. The second magnet 118d is movably provided in the width direction A4 by sliding the lower end portion 118g of the accommodating member 118f along the rail member 101d in a state in which the first housing 101 is opened in the medium conveying apparatus 100. Thus, the second magnet 118d is provided detachably from the medium conveying apparatus 100.

Hereinafter, the operations of the removal mechanism 118 will be described.

When the medium is conveyed by the conveying roller, as illustrated in FIG. 3A, the first magnet 118b is located at the opposed position opposing the side surface 101c by the moving mechanisms 118c. When a magnetic material is placed on the medium conveyed by the conveying roller, the magnetic material is attracted by the first magnetic force of the first magnet 118b and adhered to the side surface 101c facing the first magnet 118b.

The magnetic material such as a staple or a clip sandwiched between a plurality of media placed on the medium tray 103 moves riding on the lower medium among the media sandwiching the magnetic material, when the lower medium is conveyed. By the first magnet 118b located above the medium conveyance path R, the medium conveying apparatus 100 can remove the magnetic material that moves riding on the medium.

Further, the removal mechanism 118 is located between the conveying roller and the imaging device 119, in the medium conveying direction A2. Thus, the medium conveying apparatus 100 can suppress that the magnetic material such as a staple or a clip moves to a position of the imaging device 119, and an imaging surface (a glass surface) of the imaging device 119 is scratched by the magnetic material, without stopping the conveyance of the medium. As a result, the medium conveying apparatus 100 can suppress that noise due to a scratch, etc., of the imaging surface is generated in an image in which the medium is imaged, to keep the quality of the image good.

After a rear end of the medium conveyed by the conveying roller passes through a position of the removal mechanism 118, as illustrated in FIG. 3B, the first magnet 118b is moved by the moving mechanism 118c to the non-opposed position not facing the side surface 101c. Thereby, the magnetic material attracted to the first magnet 118b and adhered to the side surface 101c is attracted by the second magnetic force of the second magnet 118d, adhered to an inner surface of the accommodation member 118f, and accommodated in the accommodation member 118f. In this manner, the moving mechanism 118c attracts the magnetic material attracted to the first magnet 118b, to the second magnet 118d by moving the first magnet 118b, and transfers the magnetic material from the first magnet 118b to the second magnet 118d.

In particular, the moving mechanism 118c moves the first magnet 118b so that the first magnet 118b is located on the upper side. Thereby, the moving mechanism 118c can change a direction of the first magnetic force so that the magnetic material attracted to the first magnet 118b moves upward, and can attract the magnetic material to the second magnet 118d well.

The second magnet 118d accommodating a magnetic material such as a staple or a clip is located above the first magnet 118b, i.e., at a position apart from the medium conveyance path R. The medium conveyance apparatus 100 can secure a sufficient space for accommodating the magnetic material, since the second magnet 118d is located at a position apart from the vicinity of the medium conveyance path R where various components such as rollers and sensors need to be located.

The force attracting the magnetic material by the magnet varies according to a distance, the larger the distance between the magnet and the medium conveyance path R, the larger the magnetic force of the magnet necessary for the magnetic material. In the medium conveying apparatus 100, the first magnet 118b is located between the second magnet 118d and the medium conveyance path R, and the magnetic material attracted to the first magnet 118b is attracted to the second magnet 118d by the first magnet 118b moved by the moving mechanism 118c. The medium conveying apparatus 100 can suppress an increase in equipment cost since the first magnet 118b is located in the vicinity of the medium conveyance path R, and thereby, the magnetic material can be removed by utilizing an inexpensive magnet whose magnetic force is small. Further, the medium conveying apparatus 100 can suppress that damage to data stored in a magnetic stripe occurs when an ID (Identification) card having the magnetic stripe is conveyed, by utilizing a magnet whose magnetic force is small.

The second magnet 118d is detached from the medium conveyance apparatus 100 by a user at an arbitrary timing when the conveyance of the medium is completed, and the magnetic material accommodated in the accommodating member 118f is removed. Since the second magnet 118d is provided detachably from the medium conveying apparatus 100, the user can properly clean the medium conveying apparatus 100. When the accommodation space of the accommodation member 118f is sufficiently large and a sufficient amount of magnetic material can be accommodated in the accommodation member 118f, the second magnet 118d may be fixed in the medium conveying apparatus 100.

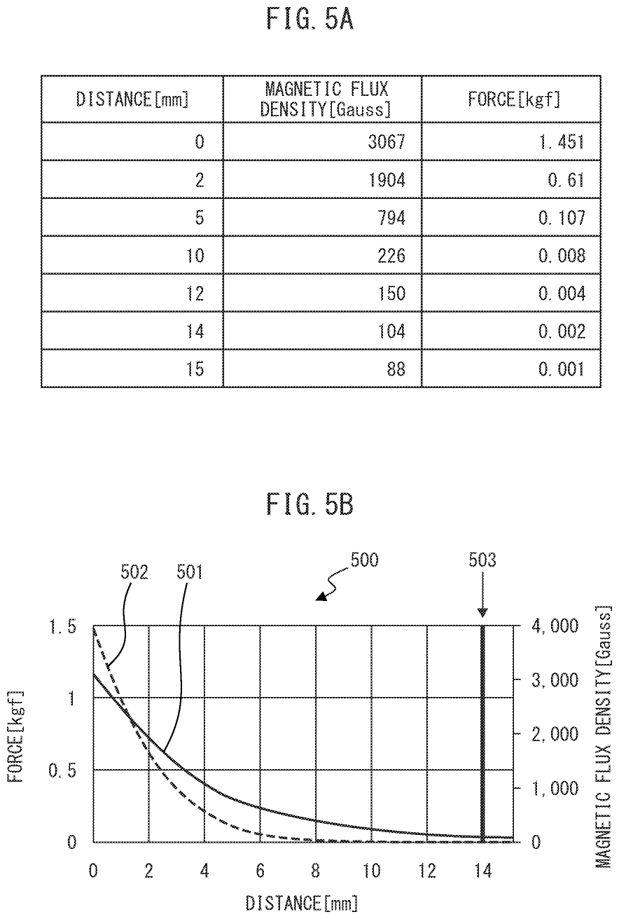

FIG. 5A is a table illustrating a relation between a distance [mm] from a neodymium magnet having a diameter of 10 mm and a thickness of 3 mm, and a magnetic flux density [Gauss] by the magnet at a position apart by the distance, and a force [kgf] applied to the magnetic material existing at that position by the magnet.

FIG. 5B is a graph 500 illustrating the relations illustrated in the table of FIG. 5A.

In the graph 500 of FIG. 5B, the horizontal axis indicates the distance [mm] from the neodymium magnet described above, the vertical axis indicates the magnetic flux density [Gauss] by the magnet at a position apart by the distance and the force [kgf] applied to the magnetic material existing at the position by the magnet. A solid line 501 in FIG. 5A indicates the relationship between the distance from the magnet and the magnetic flux density by the magnet at the position apart by the distance. A dotted line 502 indicates the relationship between the distance from the magnet and the force applied to the magnetic material existing at the position by the magnet. As illustrated in FIG. 5B, the further apart from the magnet, the smaller the magnetic flux density by the magnet and the force applied to the magnetic material existing at the position by the magnet.

The weight per one general staple is less than 1 g, and the staple can be attracted well by a force of 0.002 kgf or more. When the neodymium magnet is used as the first magnet 118b, if the distance between the first magnet 118b and the medium conveyance path R is 14 mm or less (left side of the line 503), and the magnetic flux density in the medium conveyance path R is 104 Gauss or more, staples are attracted satisfactorily.

In order for the magnetic material moving in the medium conveyance path R to be attracted by the first magnet 118b and adhered to the side surface 101c, the magnetic force applied to the magnetic material by the first magnet 118b needs to be larger than the magnetic force applied to the magnetic material by the second magnet 118d. As illustrated in FIG. 3A, a distance h1 from the first magnet 118b to the medium conveyance path R is smaller than a distance (h1+h2) from the second magnet 118d to the medium conveyance path R by a distance h2. Therefore, if the magnetic force generated by the second magnet 118d is not extremely larger than the magnetic force generated by the first magnet 118b, the magnetic force applied to the magnetic material by the first magnet 118b is larger than the magnetic force applied to the magnetic material by the second magnet 118d.

In addition, as described above, the staple can be attracted well by a force of 0.002 kgf or more. If the force applied to the magnetic material by the second magnet 118d is 0.002 kgf or more, the staple attracted to the first magnet 118b is attracted well by the second magnet 118d when the magnetic force by the first magnet 118b is turned off. When the neodymium magnet described above is used as the second magnet 118d, if the distance between the second magnet 118d and the first magnet 118b is 14 mm or less, the magnetic flux density by the second magnet 118d around the first magnet 118b becomes 104 Gauss or more. In this case, the staple attracted to the first magnet 118b is attracted well by the second magnet 118d when the magnetic force by the first magnet 118b is turned off.

For example, when the neodymium magnet described above is used as the first magnet 118b and the second magnet 118d and both the distance h1 from the first magnet 118b to the medium conveyance path R and the distance h2 from the second magnet 118d to the first magnet 118b are 14 mm, all of the above conditions are satisfied.

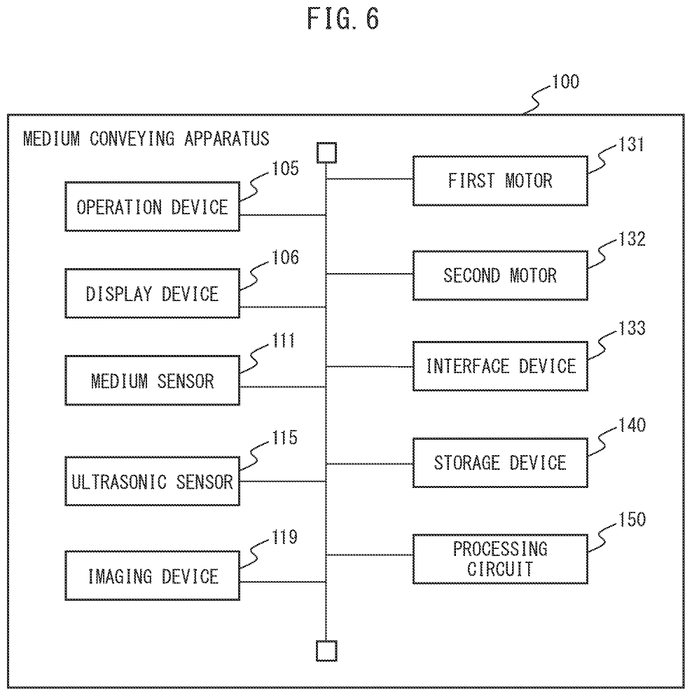

FIG. 6 is a block diagram illustrating a schematic configuration of the medium conveying apparatus 100.

The medium conveying apparatus 100 further includes a first motor 131, a second motor 132, an interface device 133, a storage device 140 and a processing circuit 150, etc., In addition to the configuration described above.

The first motor 131 includes one or more motors and rotates the pick roller 112, the feed roller 113, the brake roller 114, and the first to eighth conveyance rollers 116a to 116h by a control signal from the processing circuit 150 to feed and convey the medium. The first to eighth driven rollers 117a to 117h may be provided to rotate by the driving force from the motor rather than to be driven to rotate according to the rotation of each conveyance roller.

The second motor 132 generates a driving force to rotate the moving mechanism 118c in response to a control signal from the processing circuit 150 to move the first magnet 118b between the opposed position and the non-opposed position.

The interface device 133 includes, for example, an interface circuit conforming to a serial bus such as universal serial bus (USB), is electrically connected to an unillustrated information processing device (for example, a personal computer or a mobile information terminal), and transmits and receives an input image and various types of information. Further, a communication device including an antenna transmitting and receiving wireless signals, and a wireless communication interface circuit for transmitting and receiving signals through a wireless communication line in conformance with a predetermined communication protocol may be used in place of the interface device 133. For example, the predetermined communication protocol is a wireless local area network (LAN).

The storage device 140 includes a memory device such as a random access memory (RAM) or a read only memory (ROM), a fixed disk device such as a hard disk, or a portable storage device such as a flexible disk or an optical disk. Further, the storage device 140 stores a computer program, a database, a table, etc., used for various types of processing in the medium conveying apparatus 100. The computer program may be installed on the storage device 140 from a computer-readable, non-transitory medium such as a compact disc read only memory (CD-ROM), a digital versatile disc read only memory (DVD-ROM), etc., by using a well-known setup program, etc.

The processing circuit 150 operates in accordance with a program previously stored in the storage device 140. The processing circuit 150 is, for example, a CPU (Central Processing Unit). The processing circuit 150 may be a digital signal processor (DSP), a large scale integration (LSI), an application specific integrated circuit (ASIC), a field-programmable gate array (FPGA), etc.

The processing circuit 150 is connected to the operation device 105, the display device 106, the medium sensor 111, the ultrasonic sensor 115, the imaging device 119, the first motor 131, the second motor 132, the interface device 133 and the storage device 140, etc., and controls each of these units. The processing circuit 150 controls the first motor 131 to convey the medium, and controls the imaging device 119 to acquire an input image, and transmits the acquired input image to the information processing apparatus via the interface device 133. The processing circuit 150 controls the second motor 132 to move the first magnet 118b by controlling the moving mechanism 118c.

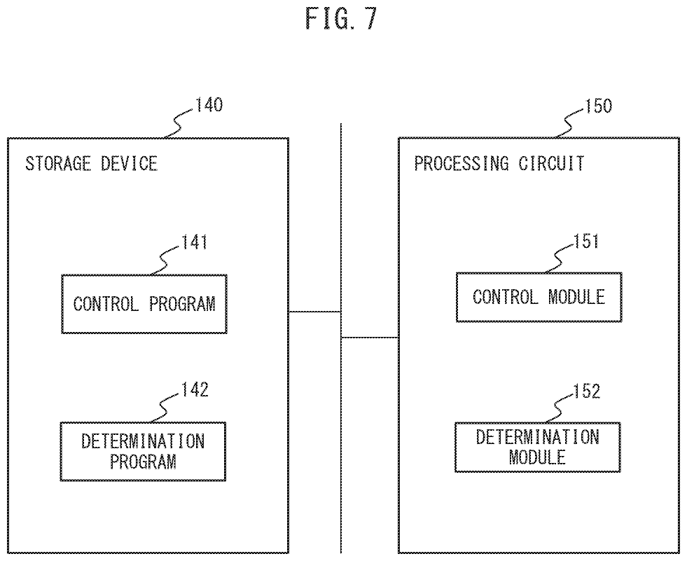

FIG. 7 is a diagram illustrating schematic configurations of a storage device 140 and a processing circuit 150.

As illustrated in FIG. 7, each program such as the control program 141 and the determination program 142, etc., is stored in the storage device 140. Each of these programs is a functional module implemented by software operating on a processor. The processing circuit 150 reads each program stored in the storage device 140, and operates in accordance with each read programs. Thus, the processing circuit 150 functions as a control module 151 and the determination module 152.

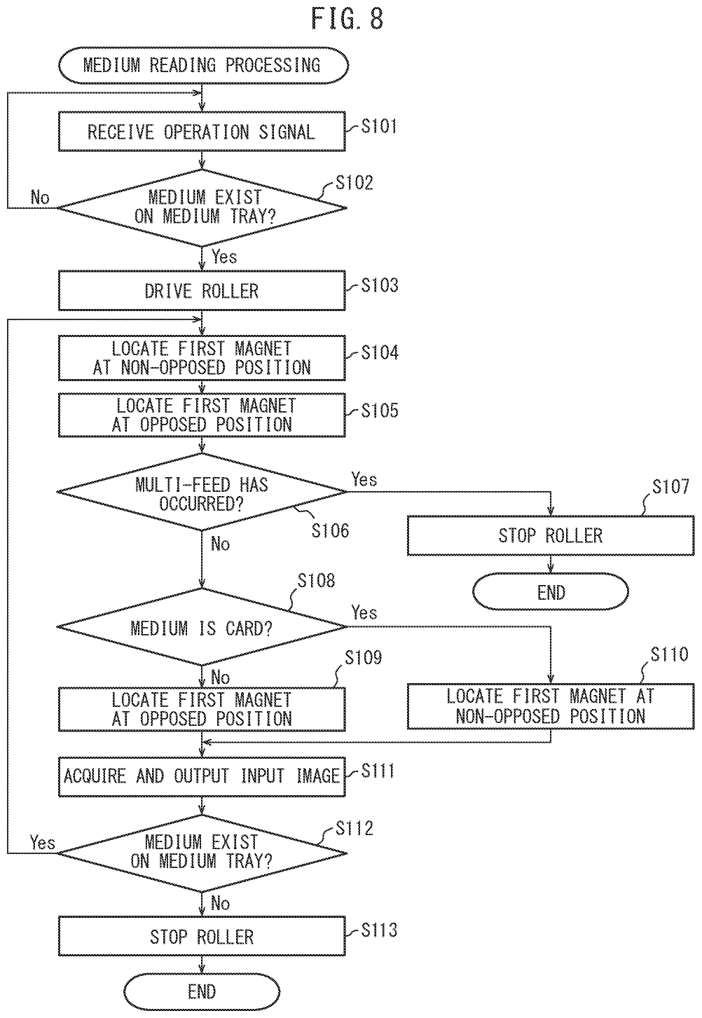

FIG. 8 is a flowchart illustrating an operation example of the medium reading processing.

Referring to the flowchart illustrated in FIG. 8, an operation example of the medium reading processing in the medium conveying apparatus 100 will be described below. The operation flow described below is executed mainly by the processing circuit 150 in cooperation with each element in the medium conveying apparatus 100, in accordance with a program previously stored in the storage device 140.

First, the control module 151 stands by until an instruction to read a medium is input by the user by use of the operation device 105 or the information processing device, and an operation signal instructing to read the medium is received from the operation device 105 or the interface device 133 (step S101).

Next, the control module 151 acquires the medium signal from the medium sensor 111, and determines whether or not the medium is placed on the medium tray 103 based on the acquired medium signal (step S102). When a medium is not placed on the medium tray 103, the control module 151 returns the processing to step S101 and stands by until newly receiving an operation signal from the operation device 105 or the interface device 133.

On the other hand, when the medium is placed on the medium tray 103, the control module 151 drives the motor for moving the medium tray 103 to move the medium tray 103 to a position capable of feeding the medium. The control module 151 rotates the pick roller 112, the feed roller 113, the brake roller 114, and the first to eighth conveyance rollers 116a to 116h by driving the first motor 131, to feed and convey the medium placed on the medium tray 103 (step S103).

Next, the control module 151 rotates the moving mechanism 118c by driving the second motor 132, to locate the first magnet 118b at the non-opposed position (step S104). Thereby, the first magnetic force by the first magnet 118b is not applied to the magnetic material currently attracted by the first magnetic force of the first magnet 118b and adhered to the side surface 101c. The magnetic material is attracted by the second magnetic force of the second magnet 118d, and is attached to the accommodation member 118f. When the first magnet 118b is currently located at the non-opposed position, the control module 151 may omit the process of step S104.

Next, the control module 151 rotates the moving mechanism 118c by driving the second motor 132, to locate the first magnet 118b at the opposed positions (step S105).

Next, the determination module 152 determines whether or not the multi-feed of the medium has occurred (step S106). The determination module 152 determines that a front end of the medium has passed through a position of the ultrasonic sensor 115 when a predetermined time has elapsed since the start of feeding of the medium. The determination module 152 may determine whether or not the front end of the medium has passed through the position of the ultrasonic sensor 115, based on a detection result of the medium by the medium sensor (not shown) located around the ultrasonic sensor 115. When the determination module 152 determines that the front end of the medium has passed through the position of the ultrasonic sensor 115, the determination module 152 acquires the ultrasonic signal from the ultrasonic sensor 115 and determines whether or not a signal value of the acquired ultrasonic signal is less than the multi-feed threshold value.

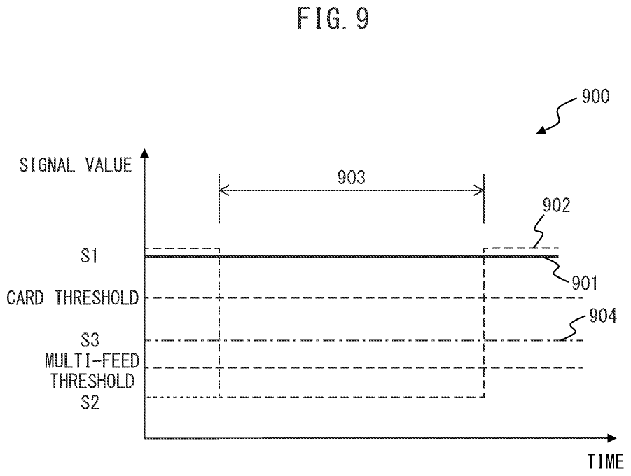

FIG. 9 is a schematic diagram for illustrating a characteristic of an ultrasonic signal.

In a graph 900 in FIG. 9, a solid line 901 represents a characteristic of an ultrasonic signal when one sheet of paper is conveyed as a medium, and a dotted line 902 represents a characteristic of an ultrasonic signal when multi-feed of paper is occurring. The horizontal axis of graph 900 indicates time, and the vertical axis indicates a signal value of the ultrasound signal. Due to occurrence of multi-feed, a signal value of the ultrasonic signal in the dotted line 902 declines in a section 903. The multi-feed threshold value is set to a value between a signal value S1 of the ultrasonic signal when one sheet of paper is conveyed and a signal value S2 of the ultrasonic signal when multi-feed of paper is occurring. By determining whether or not a signal value of the ultrasonic signal is less than the multi-feed threshold value, the determination module 152 can determine whether or not the multi-feed of the medium is occurring.

The determination module 152 determines that the multi-feed has occurred when the signal value of the ultrasonic signal is less than the multi-feed threshold value, and the determination module 152 determines that the multi-feed has not occurred when the signal value of the ultrasonic signal is equal to or more than the multi-feed threshold value. Thus, the determination module 152 determines whether or not the multi-feed of the medium has occurred by comparing the ultrasonic signal with the multi-feed threshold value.

When the determination module 152 determines that the multi-feed has occurred, the control module 151 stops each roller by stopping the first motor 131, to stop the feeding and conveying of the medium, as an abnormal process (step S107). Further, the control module 151 notifies the user that an abnormality has occurred, by using a speaker (not shown), LEDs, etc., as the abnormality process, and terminates the series of steps. The control module 151 may stop conveying the next medium after eject of the currently conveyed medium, instead of immediately stopping conveying the medium, as the abnormal processing.

On the other hand, when the determination module 152 determines that the multi-feed has not occurred, the determination module 152 determines whether or not the conveyed medium is a card (step S108). The determination module 152 determines whether or not the signal value of the ultrasonic signal acquired from the ultrasonic sensor 115 is less than a card threshold value.

A one-dot chain line 904 illustrated in FIG. 9 indicates characteristics of the ultrasonic signal when a plastic ID card is conveyed. The signal value of the ultrasonic signal when the ID card is conveyed is less than the signal value of the ultrasonic signal when one sheet of paper is conveyed. The card threshold value is set to a value between the signal value S1 of the ultrasonic signal when one sheet of paper is conveyed and the signal value S3 of the ultrasonic signal when the ID card is conveyed. The card threshold is set to a value larger than the multi-feed threshold. Thus, the determination module 152 can determine whether the conveyed medium is a card or a paper by determining whether or not the signal value of the ultrasonic signal is less than the card threshold value.

The determination module 152 determines that the conveyed medium is a card when the signal value of the ultrasonic signal is less than the card threshold value, and the determination module 152 determines that the conveyed medium is a paper when the signal value of the ultrasonic signal is equal to or more than the card threshold value. As described above, the determination module 152 determines whether the conveyed medium is a card or a paper by comparing the ultrasonic signal with the card threshold value larger than the multi-feed threshold value.

When the determination module 152 determines that the conveyed medium is a paper, the control module 151 continues to place the first magnet 118b at the opposed position without driving the second motor 132 (step S109).

On the other hand, when the determination module 152 determines that the conveyed medium is a card, the control module 151 rotates the moving mechanism 118c by driving the second motor 132, to arrange the first magnet 118b at the non-opposed position in step S110. That is, the control module 151 controls the moving mechanism 118c to move the first magnet 118b away from the medium conveyance path R. Thus, the medium conveying apparatus 100 can suppress that the first magnetic force by the first magnet 118b is applied to the conveyed ID card, and the damage of the data stored in the magnetic stripe of the ID card occurs.

Next, the control module 151 causes the imaging device 119 to image the conveyed medium to acquire the input image, and outputs the acquired input image by transmitting it to the information processing apparatus via the interface device 133 (step S111). The control module 151 acquires the input image after a rear end of the medium has passed through the imaging position of the imaging device 119. The control module 151 determines that the rear end of the medium has passed through the imaging position of the imaging device 119 when a predetermined time has elapsed since the start of feeding of the medium. The control module 151 may determine whether or not the rear end of the medium has passed through the imaging position of the imaging device 119, based on a detection result of the medium by a medium sensor (not shown) located around the imaging device 119.

Next, the control module 151 determines whether or not a medium remains on the medium tray 103, based on the medium signal received from the medium sensor 111 (step S112). When a medium remains on the medium tray 103, the control module 151 returns the process to step S104 and repeats the processes in steps S104 to S112.

On the other hand, when a medium does not remain on the medium tray 103, the control module 151 stops each roller by stopping the first motor 131, to stop the feeding and conveying of the medium (step S113), and terminates the series of steps.

The process of step S104 may be executed, not prior to the process of step S105, but after the process of step S111. That is, the process of adhering the magnetic material adhered to the side surface 101c to the accommodation member 118f may be executed, not before the medium is conveyed, but after the medium is conveyed. The processes of step S104 and S105 may be executed prior to the process of step S103 or after the process of step S113. That is, the movement of the first magnet 118b may not be executed every time one medium is conveyed, but be executed every time media group placed collectively on the medium tray 103 are conveyed. Also, the processes of step S106 to S107 and/or step S108 to S110 may be omitted.

As described in detail above, the medium conveying apparatus 100 includes the first magnet 118b located in the vicinity of the medium conveyance path R and attracting the magnetic material such as a staple or a clip, and the second magnet 118d attracting the magnetic material attracted to the first magnet 118b. The media conveying device 100 can accommodate the magnetic material at a position away from the medium conveyance path R, at which parts necessary for the medium conveying are not located, by using two magnets to transfer the magnetic material between the two magnets. Therefore, the medium conveying apparatus 100 can appropriately remove the magnetic material moving with the conveyed medium.

Since a large number of parts necessary for the medium conveying are located in the vicinity of the medium conveyance path R, it is difficult to secure a sufficient space to accommodate a large number of magnetic materials. Therefore, when trying to accommodate the magnetic material in the vicinity of the medium conveyance path R, the magnetic material previously accommodated stands in the way, it may be difficult to accommodate the new magnetic material (difficult to adhere the new magnetic material to the magnet). The medium conveying apparatus 100 can secure a sufficient space capable of accommodating a large number of magnetic materials, and can remove the magnetic material appropriately, by accommodating the magnetic material at a position away from the medium conveyance path R.

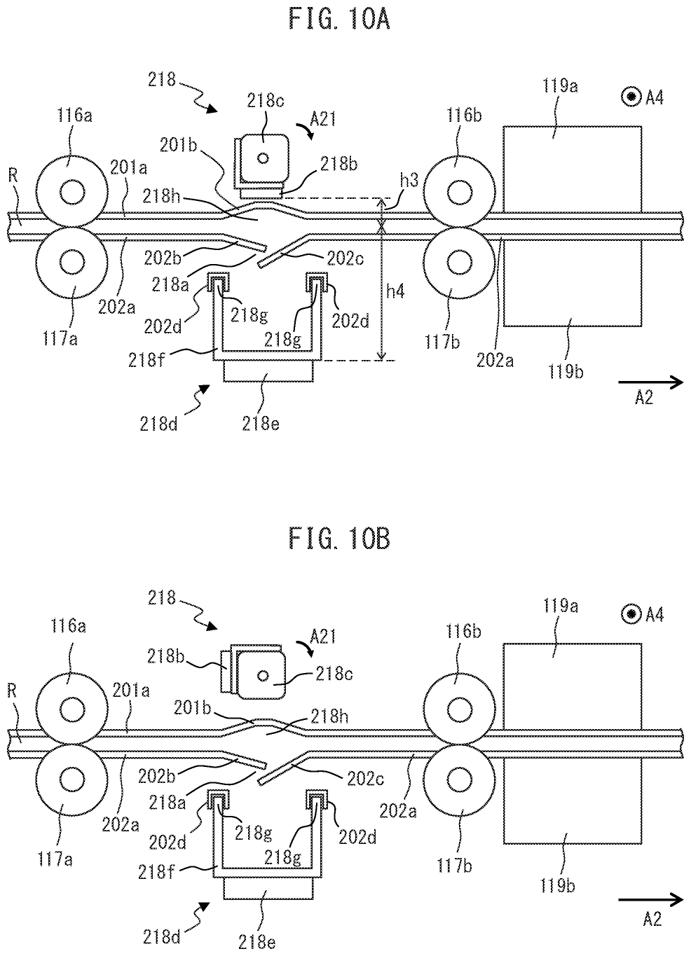

FIGS. 10A and 10B are schematic diagrams for illustrating a removal mechanism 218 of a medium conveying apparatus according to another embodiment.

As illustrated in FIGS. 10A and 10B, the removal mechanism 218 is located between the first conveyance roller 116a and the second conveyance roller 116b, i.e., between the conveying roller and the imaging device 119 in the medium conveying direction A2, similarly to the removal mechanism 118.

The removal mechanism 218 includes a hole 218a, a first magnet 218b, a moving mechanism 218c, a second magnet 218d, a recess 218h, etc.

As illustrated in FIGS. 10A and 10B, a part of a first guide 201a formed above the medium conveyance path R is bent so as to form a recess upward between the first conveyance roller 116a and the second conveyance roller 116b in the medium conveying direction A2. In the first guide 201a, a curved portion 201b is formed by a portion bent upward, and the recess 218h is provided upward. On the other hand, a second guide 202a formed below the medium conveyance path R is folded so as to be inclined downward between the first conveyance roller 116a and the second conveyance roller 116b in the medium conveying direction A2. The portion folded downward of the second guide 202a forms two inclined surfaces 202b and 202c extending inclined downward and overlapping each other in the medium conveying direction A2, and the hole 218a is provided between the inclined surface 202b and the inclined surface 202c. In addition, the slope surface 202b on the upstream side is located above the inclined surface 202c on the downstream side. Thus, it is suppressed that the front edge of the conveyed medium collides with the inclined surfaces 202b or 202c, and a jam of the medium occurs.

The first magnet 218b is a permanent magnet having a structure similar to that of the first magnet 118b, and is located above the medium conveyance path R so as to be in contact with a surface opposite to the recess 218h, of the curved portion 201b. When the first guide 201a is formed of a ferromagnetic material, the curved portion 201b of the first guide 201a becomes magnetized by the first magnetic force of the first magnet 218b, and functions as a magnet. The first magnet 218b may be located in a range capable of attracting the magnetic material moving with the medium by the first magnetic force, and may be located so as to be apart from the curved portion 201b.

The moving mechanism 218c has a structure similar to that of the moving mechanism 118c, and is located on the opposite side of the recess 218h with respect to the curved portion 201b. The first magnet 218b is attached along the width direction A4 to one side surface extending in the width direction A4, of the moving mechanism 218c. That is, the moving mechanism 218c rotates by the driving force from the second motor 132 to move the first magnet 218b between an opposed position opposing the bending portion 201b and a non-opposed position not opposing the bending portion 201b.

The second magnet 218d has a structure similar to that of the second magnet 118d, and is located below the medium conveyance path R so that an opening is opened upward on the lower end side of the two inclined surfaces 202b and 202c and faces the hole 218a. The second magnet 218d includes a magnet member 218e and a housing member 218f.

The magnet member 218e is a permanent magnet having a structure similar to that of the magnet member 118e, and the accommodation member 218f is formed of a ferromagnetic material having a structure similar to that of the accommodation member 118f. The magnet member 218e is attached so as to so as to be in contact with a surface opposite to the opening, of the bottom of the opening of the accommodation member 218f. The accommodation member 218f becomes magnetized by the second magnetic force of the magnet member 218e, and functions as a magnet. The magnet member 218e may be located in a range capable of attracting the magnetic material attracted to the first magnet 218b by the second magnetic force, and may be located so as to be apart from the accommodation member 218f. The accommodation member 218f may be formed of a material other than a magnetic material.

The first magnetic force and the second magnetic force are set so that the first magnetic force applied to the magnetic material existing at a position facing the curved portion 201b in the medium conveyance path R is larger than the sum of the second magnetic force and gravitational force applied to the magnetic material when the first magnet 218b is located at the opposed position. The first magnetic force and the second magnetic force are set so that the first magnetic force applied to the magnetic material existing in the range from the curved portion 201b to the accommodation member 218f is smaller than the sum of the second magnetic force and gravitational force applied to the magnetic material when the first magnet 218b is located at the non-opposed position. The first magnetic force and the second magnetic force are set so that the first magnetic force applied to the magnetic material accommodated in the accommodation member 218f is smaller than the sum of the second magnetic force and the gravitational force applied to the magnetic material, regardless of the position where the first magnet 118b is located.

The second housing 102 is provided with a rail member 202d extending in the width direction A4 and engaging with an upper end portion 218g of the accommodation member 218f. A door capable of opening and closing is formed on a side surface of the medium conveying apparatus, and thereby, the second magnet 218d is provided movably in the width direction A4 by sliding the upper end portion 218g of the accommodating member 218f along the rail member 202d. Thus, the second magnet 218d is provided detachably from the medium conveying apparatus.

Hereinafter, the operations of the removal mechanism 218 will be described.

When the medium is conveyed by the conveying roller, as illustrated in FIG. 10A, the first magnet 218b is located at the opposed position opposing the curved portion 201b by the moving mechanism 218c. When the magnetic material is placed on the medium conveyed by the conveying roller, the magnetic material is attracted by the first magnetic force of the first magnet 218b and adhered to the curved portion 201b facing the first magnet 218b.

By the first magnet 218b located above the medium conveyance path R, the medium conveying apparatus can remove the magnetic material that moves riding on the medium. Further, by the removal mechanism 218 located between the conveying roller and the imaging device 119, the medium conveying apparatus can suppress that the imaging surface of the imaging device 119 is scratched by the magnetic material.

After the rear end of the medium conveyed by the conveying roller passes through a position of the removal mechanism 218, as illustrated in FIG. 10B, the first magnet 218b is moved by the moving mechanism 218c to the non-opposed position not facing the bending portion 201b. Thereby, the magnetic material attracted to the first magnet 218b and adhered to the curved portion 201b is attracted by the second magnetic force of the second magnet 218d, adhered to an inner surface of the accommodation member 218f, and accommodated in the accommodation member 218f. In this manner, the moving mechanism 218c attracts the magnetic material attracted to the first magnet 218b, to the second magnet 218d by moving the first magnet 218b, and transfers the magnetic material from the first magnet 218b to the second magnet 218d.

The second magnet 218d accommodating a magnetic material is located below the medium conveyance path R, i.e., below the first magnet 218b. Therefore, since the second magnet 218d can attract the magnetic material by gravitational force in addition to the second magnetic force, the second magnet 218d can attract the magnetic material even when it is located at a position away from the medium conveyance path R. The medium conveyance apparatus can secure a sufficient space for accommodating the magnetic material, since the second magnet 218d is located at a position apart from the vicinity of the medium conveyance path R where various components such as rollers and sensors need to be located.

On the other hand, the medium conveying apparatus can suppress an increase in equipment cost since the first magnet 218b is located in the vicinity of the medium conveyance path R, and thereby, the magnetic material can be removed by utilizing an inexpensive magnet whose magnetic force is small. Further, the medium conveying apparatus can suppress that damage to data stored in a magnetic stripe occurs when an ID card having the magnetic stripe is conveyed, by utilizing a magnet whose magnetic force is small.

The second magnet 218d is detached from the medium conveyance apparatus by a user at an arbitrary timing when the conveyance of the medium is completed, and the magnetic material accommodated in the accommodating member 218f is removed. Since the second magnet 218d is provided detachably from the medium conveying apparatus, the user can properly clean the medium conveying apparatus. When the accommodation space of the accommodation member 218f is sufficiently large and a sufficient amount of magnetic material can be accommodated in the accommodation member 218f, the second magnet 218d may be fixed in the medium conveying apparatus.

When a neodymium magnet having a diameter of 10 mm and a thickness of 3 mm is used as the first magnet 218b, if the distance between the first magnet 218b and the medium conveyance path R is 14 mm or less, and the magnetic flux density in the medium conveyance path R is 104 Gauss or more, staples are attracted satisfactorily.

In order for the magnetic material moving in the medium conveyance path R to be attracted by the first magnet 218b and adhered to the curved portion 201b, the magnetic force applied to the magnetic material by the first magnet 218b needs to be larger than the magnetic force applied to the magnetic material by the second magnet 218d. As illustrated in FIG. 10A, the distance h3 from the first magnet 218b to the medium conveyance path R is smaller than the distance h4 from the second magnet 218d to the medium conveyance path R. Therefore, if the magnetic force generated by the second magnet 218d is not extremely larger than the magnetic force generated by the first magnet 218b, the magnetic force applied to the magnetic material by the first magnet 218b is larger than the magnetic force applied to the magnetic material by the second magnet 218d.

As described above, the second magnet 218d can attract the magnetic material by gravitational force in addition to the second magnetic force, and an inexpensive magnet whose magnetic force is smaller than that of the second magnet 118d may be used as the second magnet 218d. Therefore, the medium conveying apparatus can suppress an increase in equipment cost.

As the second magnet 218d, a magnet generating a magnetic force of an appropriate magnitude is used, in consideration of a thickness of the accommodation member 218f. For example, when the neodymium magnet described above is used as the first magnet 218b and the second magnet 218d, the distance h3 from the first magnet 218b to the medium conveyance path R is 14 mm, and the distance h4 from the second magnet 218d to the medium conveyance path R is 28 mm, all of the above conditions are satisfied.

As described in detail above, even when the second magnet 218d is located below the medium conveyance path R, the medium conveying apparatus can appropriately remove the magnetic material moving together with the conveyed medium.

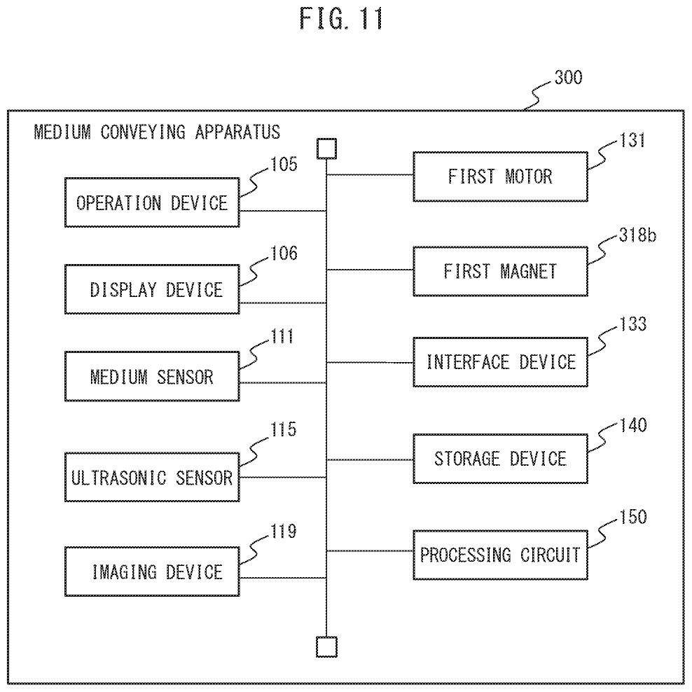

FIG. 11 is a block diagram illustrating a schematic configuration of a medium conveying apparatus 300 according to another embodiment.

The medium conveying apparatus 300 includes the respective configurations of the medium conveying apparatus 100. However, the second motor 132 is omitted in the medium conveying apparatus 300, the medium conveying apparatus 300 further includes a first magnet 318b.

The first magnet 318b is an electromagnet capable of changing the first magnetic force applied to the magnetic material moving in the medium conveyance path R to a magnetic force more than the second magnetic force applied to the magnetic material by the second magnet 118d or 218d and a magnetic force less than the second magnetic force, by a control signal from the processing circuit 150. The first magnet 318b is set to be enabled by being set the first magnetic force applied to the magnetic material to a magnetic force more than the second magnetic force applied to the magnetic material, by the control signal from the processing circuit 150. On the other hand, the first magnet 318b is set to be disabled, by being set the first magnetic force applied to the magnetic material to a magnetic force less than the second magnetic force applied to the magnetic material, by the control signal from the processing circuit 150.

As a removal mechanism of the medium conveying apparatus 300, for example, the removal mechanism 118 illustrated in FIG. 3A is used. In this case, the removal mechanism of the medium conveying apparatus 300 includes the first magnet 318b instead of the first magnet 118b and the moving mechanism 118c. The first magnet 318b is fixedly located at an opposed position facing the side surface 101c. As the removal mechanism of the medium conveying apparatus 300, the removal mechanism 218 illustrated in FIG. 10A may be used. In this case, the removal mechanism of the medium conveying apparatus 300 includes the first magnet 318b instead of the first magnet 218b and the moving mechanism 218c. The first magnet 318b is fixedly located at an opposed position facing the curved portion 201b.

When the removal mechanism 118 is used, the first magnetic force when the first magnet 318b is set to be enabled is set so that the first magnetic force applied to the magnetic material existing in the range from the position facing the hole 118a in the medium conveyance path R to the side surface 101c is larger than the gravitational force applied to the magnetic material. Further, the first magnetic force when the first magnet 318b is set to be enabled is set so that the first magnetic force applied to the magnetic material existing in the range from the position facing the hole 118a in the medium conveyance path R to the side surface 101c is larger than the second magnetic force applied to the magnetic material. The first magnetic force when the first magnet 318b is set to be disabled is set so that the first magnetic force applied to the magnetic material existing in the range from the side surface 101c to the accommodation member 118f is less than the second magnetic force applied to the magnetic material. Further, the first magnetic force is set so that the first magnetic force applied to the magnetic material accommodated in the accommodation member 118f is smaller than the second magnetic force applied to the magnetic material, regardless of whether the first magnet 318b is set to be enabled or disabled.

On the other hand, when the removal mechanism 218 is used, the first magnetic force when the first magnet 318b is set to be enabled, is set so that the first magnetic force applied to the magnetic material existing at a position facing the curved portion 201b in the medium conveyance path R is more than the sum of the second magnetic force and the gravitational force applied to the magnetic material. Further, the first magnetic force when the first magnet 318b is set to be disabled, is set so that the first magnetic force applied to the magnetic material existing in the range from the curved portion 201b to the accommodation member 218f is less than the sum of the second magnetic force and the gravitational force applied to the magnetic material. Further, the first magnetic force is set so that the first magnetic force applied to the magnetic material accommodated in the accommodation member 218f is less than the sum of the second magnetic force and the gravitational force applied to the magnetic material, regardless of whether the first magnet 318b is set to be enabled or disabled.

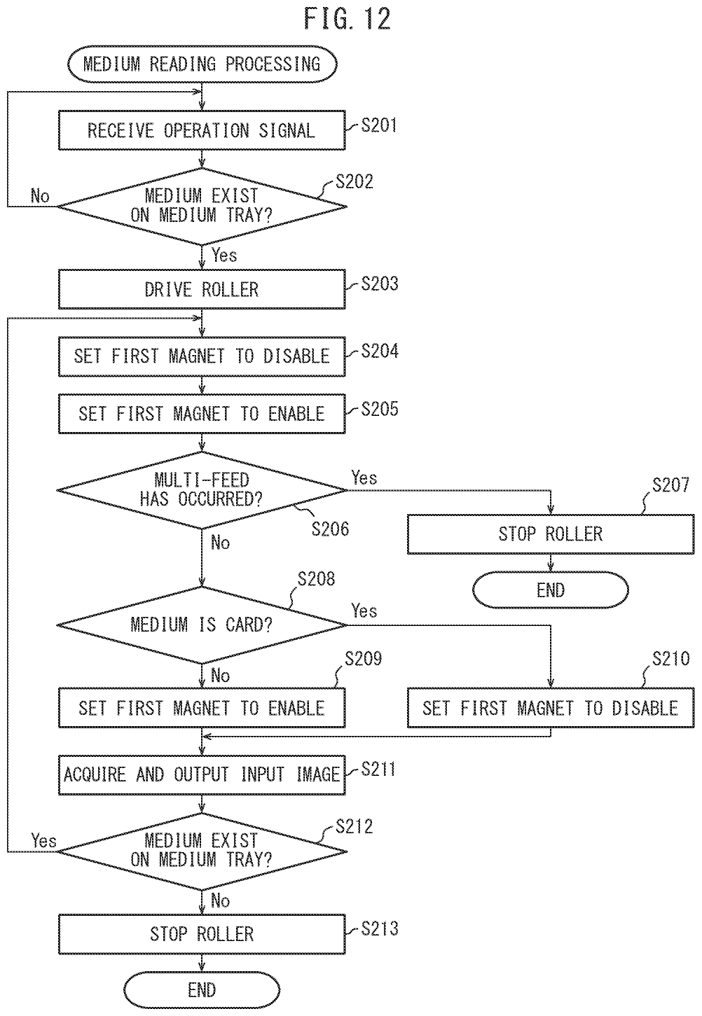

FIG. 12 is a flowchart illustrating another operation example of the medium read processing.

The medium reading processing illustrated in FIG. 12 is performed in place of the medium reading processing illustrated in FIG. 8. Referring to the flowchart illustrated in FIG. 12, an operation example of the medium reading processing in the medium conveying apparatus 300 will be described below. The operation flow described below is executed mainly by the processing circuit 150 in cooperation with each element in the medium conveying apparatus 300, in accordance with a program previously stored in the storage device 140. Since the processing of steps S201 to S203, S206 to S208, S211 to S213 of FIG. 12 is the same as the processing of steps S101 to S103, S106 to S108, S111 to S113 of FIG. 8, detailed descriptions thereof will be omitted. Hereinafter, only steps S204 to S205, S209 to S210 will be described.

In step S204, the control module 151 sets the first magnet 318b to be disabled (step S204). Thus, the first magnetic force by the first magnet 318b is not applied to the magnetic material currently attracted by the first magnetic force by the first magnet 318b. The magnetic material is attracted by the second magnetic force of the second magnet, and is attached to the accommodation member. When the first magnet 318b is currently set to be disabled, the control module 151 may omit the process of step S204.

Next, the control module 151 sets the first magnet 318b to be enabled (step S205).

Further, when the determination module 152 determines that the conveyed medium is a paper in step S208, the control module 151 continues to set the first magnet 318b to be enabled (step S209).

On the other hand, when the determination module 152 determines the conveyed medium is a card, the control module 151 sets the first magnet 318b to be disabled (step S210). In particular, in this case, the control module 151 sets the first magnetic force of the first magnet 318b to off. Thus, the medium conveying apparatus 300 can suppress that the first magnetic force of the first magnet 318b is applied to the conveyed ID card, and thereby, the damage of the data stored in the magnetic stripe of the ID card occurs.

As described in detail above, even when using an electromagnet as the first magnet 318b, the medium conveying apparatus 300 can appropriately remove the magnetic material moving together with the conveyed medium. In particular, the medium conveying apparatus 300 can simplify a peripheral structure of the medium conveyance path R, and thereby, can reduce the cost of the device design.

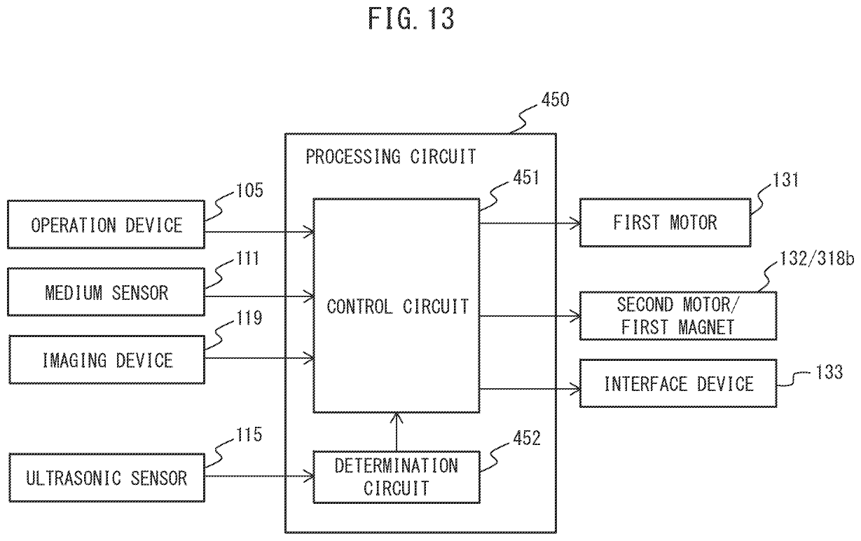

FIG. 13 is a diagram illustrating a schematic configuration of a processing circuit 450 of a medium conveying apparatus according to another embodiment.

The processing circuit 450 is used in place of the processing circuit 150 and executes the medium read processing, etc., instead of the processing circuit 150. The processing circuit 450 includes a control circuit 451 and a determination circuit 452, etc. Note that each unit may be configured by an independent integrated circuit, a microprocessor, firmware, etc.

The control circuit 451 is an example of a control module and has a function similar to the control module 151. The control circuit 451 receives the operation signal from the operation device 105, the medium signal from the medium sensor 111, and a determination result of whether or not the medium is a card from the determination circuit 452. The control circuit 451 controls the first motor 131 to convey the medium, and controls the second motor 132 to place the first magnet at the opposed position or non-opposed position, or set the first magnet 318b to be enabled or disabled, based on the received information. Further, the control circuit 451 acquires an input image from the imaging device 119, and outputs it to the interface device 133.

The determination circuit 452 is an example of a determination module and has a function similar to the determination module 152. The determination circuit 452 receives the ultrasonic signal from the ultrasonic sensor 115, determines whether or not the medium is a card based on the received ultrasonic signal, and outputs the determination result to the control circuit 451.

As described in detail above, even when the medium reading process is performed by the processing circuit 450, the medium conveying apparatus can appropriately remove the magnetic material moving together with the conveyed medium.

According to embodiments, the medium conveying apparatus can appropriately remove the magnetic material moving together with the conveyed medium.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A medium conveying apparatus comprising:
a conveying roller to convey a medium;
a first magnet to generate a first magnetic force for attracting a magnetic material moving with the medium conveyed by the conveying roller; and
a second magnet to generate a second magnetic force for attracting the magnetic material attracted to the first magnet.

2. The medium conveying apparatus according to claim 1, wherein the second magnet is provided detachably from the medium conveying apparatus.

3. The medium conveying apparatus according to claim 1, wherein
the first magnet is located above a medium conveyance path, and wherein
the second magnet is located above the first magnet.

4. The medium conveying apparatus according to claim 1, wherein
the first magnet is located above a medium conveyance path, and wherein
the second magnet is located below the medium conveyance path.

5. The medium conveying apparatus according to claim 1, further comprising a moving mechanism to attract the magnetic material attracted to the first magnet, to the second magnet by moving the first magnet.

6. The medium conveying apparatus according to claim 3, further comprising a processor to determine whether the conveyed medium is a card, and control the moving mechanism to move the first magnet away from the medium conveyance path when the processor determines that the conveyed medium is a card.

7. The medium conveying apparatus according to claim 1, wherein the first magnet is an electromagnet capable of changing the first magnetic force to a magnetic force more than the second magnetic force and a magnetic force less than the second magnetic force.

8. The medium conveying apparatus according to claim 7, further comprising a processor to determine whether the conveyed medium is a card, and set the first magnetic force to off when the processor determines that the conveyed medium is a card.

9. The medium conveying apparatus according to claim 1, further comprising an imaging device to image the medium conveyed by the conveying roller, wherein
the first magnet and the second magnet are located between the conveying roller and the imaging device, in a medium conveying direction.
